(19) United States
(12) Patent Application Publication
(10) Pub. No.: US 2021/0057707 A1
(43) Pub. Date: Feb. 25, 2021

(54) BUS BAR AND BATTERY MODULE

(71) Applicant: KABUSHIKI KAISHA TOSHIBA, Minato-ku (JP)

(72) Inventors: Wataru NITTA, Tokyo (JP); Kiminori TOYA, Kawasaki (JP)

(73) Assignee: KABUSHIKI KAISHA TOSHIBA, Minato-ku (JP)

(21) Appl. No.: 16/913,428

(22) Filed: Jun. 26, 2020

(30) Foreign Application Priority Data
Aug. 19, 2019 (JP) 2019-149795

(51) Int. Cl. H01M 2/20; H01M 2/10

(52) U.S. Cl. CPC H01M 2/202; H01M 2/1016

(57) ABSTRACT

An embodiment provides a bus bar that connects two terminals separated from each other in a first direction. The bus bar includes a first folded part, a second folded part, a relay, a first connector, and a second connector. The second folded part is apart from the first folded part in a second direction intersecting the first direction. The relay relays between the first folded part and the second folded part. The first connector is bonded to one of the terminals, and extends from the first folded part toward a side in which the second folded part is positioned. The second connector is bonded to the other of the terminals, and extends from the second folded part toward a side in which the first folded part is positioned.

### CROSS-REFERENCE TO RELATED APPLICATIONS

This application is based upon and claims the benefit of priority from Japanese Patent Application No. 2019-149795, filed Aug. 19, 2019; the entire contents of which are incorporated herein by reference.

### FIELD

Embodiments described herein relate generally to a bus bar and a battery module.

### BACKGROUND

In a battery module, etc. including a plurality of batteries, a terminal of a battery and that of another battery are electrically connected via a bus bar. In this case, the bus bar is bonded to two terminals (a first terminal and a second terminal) by laser welding, etc. The bus bar as described above requires a reduction in a temperature increase due to Joule heat in a state of current flowing. Furthermore, the bus bar requires a reduction in a stress acting on a portion bonded to the terminals even when thermal expansion occurs due to the temperature increase.

### BRIEF DESCRIPTION OF THE DRAWINGS

FIG. 1 is a perspective view schematically showing an example of a battery used for a battery module according to an embodiment;

FIG. 2 is a perspective view schematically showing an example of an electrode group used for the battery of FIG. 1 or the like;

FIG. 3 is a schematic view showing an example of the battery module according to the embodiment;

FIG. 4 is a perspective view schematically showing a bus bar according to a first embodiment;

FIG. 5 is a perspective view schematically showing the bus bar of FIG. 4 viewed from a direction different from FIG. 4;

FIG. 6 is a schematic view showing the bus bar of FIG. 4 viewed from one side in a third direction;

FIG. 7 is a schematic view showing the bus bar of FIG. 4 viewed from one side in a first direction;

FIG. 8 is a sectional view schematically showing, with a section perpendicular to or substantially perpendicular to a second direction, a state of the battery module in which two terminals are electrically connected via the bus bar of FIG. 4;

FIG. 9 is a schematic view showing the bus bar of FIG. 4 in a developed state;

FIG. 10 is a perspective view schematically showing a bus bar according to a first modification; and

FIG. 11 is a schematic view showing a state of a bus bar according to a second modification viewed from one side in a third direction.

### DETAILED DESCRIPTION

An embodiment provides a bus bar that electrically connects a first terminal and a second terminal separated from each other in a first direction. The bus bar includes a first folded part, a second folded part, a relay, a first connector, and a second connector. The second folded part is formed apart from the first folded part in a second direction intersecting the first direction. The relay relays between the first folded part and the second folded part. The first connector is bonded to the first terminal, and folded with respect to the relay at the first folded part. The first connector extends from the first folded part toward a side in which the second folded part is positioned in the second direction. The second connector is bonded to the second terminal, and folded with respect to the relay at the second folded part. The second connector extends from the second folded part toward a side in which the first folded part is positioned in the second direction.

An embodiment provides a battery module including the above-described bus bar. The battery module includes a first battery and a second battery. The first battery includes the first terminal to which the first connector of the bus bar is bonded. The second battery includes the second terminal to which the second connector of the bus bar is bonded, and the second terminal is electrically connected to the first terminal via the bus bar.

Hereinafter, embodiments will be described with reference to drawings. A battery module according to an embodiment includes a plurality of batteries. The plurality of batteries include a first battery and a second battery. The first battery includes a first terminal, and the second battery includes a second terminal. In the battery module, a bus bar electrically connects the first terminal of the first battery and the second terminal of the second battery. The bus bar is bonded to each of the first terminal and the second terminal by laser welding, etc.

[Battery]

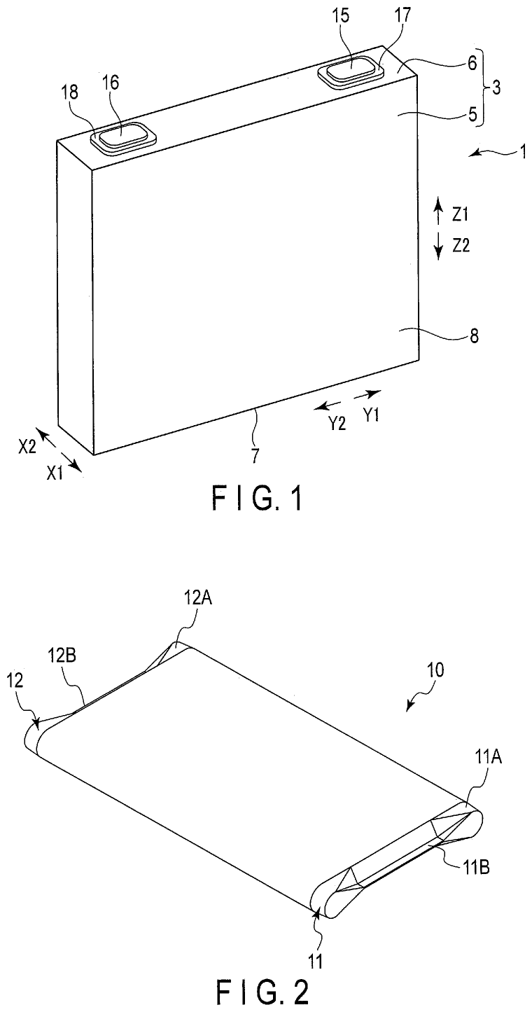

First, a battery that is provided in the battery module will be described. For a battery, a secondary battery such as a nonaqueous electrolyte secondary battery may be used. FIG. 1 shows an example of a battery 1. The battery 1 shown as an example in FIG. 1 includes a container 3. The container 3 is made of an electro-conductive material such as a metal, for example. The container 3 includes a container body 5 and a lid member 6. The container body 5 includes a bottom wall 7 and a peripheral wall 8. In the container body 5, an inner cavity is defined by the bottom wall 7 and the peripheral wall 8.

The battery 1 and container 3 shown as an example in FIG. 1 are each defined in terms of a depth direction (direction indicated by arrows X1 and X2), a lateral direction (direction indicated by arrows Y1 and Y2) intersecting (perpendicular to or substantially perpendicular to) the depth direction, and a height direction (direction indicated by arrows Z1 and Z2) intersecting (perpendicular to or substantially perpendicular to) both the depth direction and the lateral direction. The battery 1 and container 3 shown as an example in FIG. 1 each have a smaller dimension in the depth direction than each of the dimension in the lateral direction and the dimension in the height direction. The inner cavity of the container body 5 is open in the height direction toward a side opposite to a side in which the bottom wall 7 is positioned. The lid member 6 is attached to the container body 5 in an opening edge of an opening of the inner cavity. The opening of the inner cavity is covered with the lid member 6. The lid member 6 is attached to the container body 5 by welding, etc.; thereby, the inner cavity is sealed and encapsulated.

Inside the inner cavity of the container body 5, an electrode group is housed. FIG. 2 shows an example of an electrode group 10. In the example shown in FIG. 2, the electrode group 10 is formed into, for example, a flat shape, and includes a positive electrode 11 and a negative electrode 12. In the electrode group 10, a separator (not shown) is interposed between the positive electrode 11 and the negative electrode 12. The separator is made of a material having electrical insulation properties, and electrically insulates the positive electrode from the negative electrode.

The positive electrode 11 includes a positive electrode current collector 11A such as a positive electrode current collecting foil, and a positive electrode active material-containing layer (not shown) supported on a surface of the positive electrode current collector 11A. The positive electrode active material-containing layer contains a positive electrode active material. The positive electrode current collector 11A includes a positive electrode current collecting tab 11B as a portion not supporting the positive electrode active material-containing layer. The negative electrode 12 includes a negative electrode current collector 12A such as a negative electrode current collecting foil, and a negative electrode active material-containing layer (not shown) supported on a surface of the negative electrode current collector 12A. The negative electrode active material-containing layer contains a negative electrode active material. The negative electrode current collector 12A includes a negative electrode current collecting tab 12B as a portion not supporting the negative electrode active material-containing layer. In the electrode group 10 shown as an example in FIG. 2, the positive electrode current collecting tab 11B protrudes from the negative electrode 12. The negative electrode current collecting tab 12B protrudes from the positive electrode 11 toward a side opposite to the protruding direction of the positive electrode current collecting tab 11B.

In the battery 1 shown as an example in FIG. 1, a pair of terminals (electrode terminals) 15 and 16 are attached to an outer surface of the lid member 6. One of the terminals 15 and 16 is a positive electrode terminal of the battery 1 while the other is a negative electrode terminal. Thus, the terminals 15 and 16 have electrical polarities opposite to each other. The positive electrode current collecting tab 11B is electrically connected to the positive electrode terminal which is a corresponding one of the terminals 15 and 16 via one or more positive electrode leads (not shown) arranged in the inner cavity of the container body 5. The negative electrode current collecting tab 12B is electrically connected to the negative electrode terminal which is a corresponding one of the terminals 15 and 16 via one or more negative electrode leads (not shown) arranged in the inner cavity of the container body 5.

On the outer surface of the lid member 6, an insulating member 17 is interposed between the terminal 15 and the lid member 6, and the insulating member 17 electrically insulates the terminal 15 from the container 3. Similarly, on the outer surface of the lid member 6, an insulating member 18 is interposed between the terminal 16 and the lid member 6, and the insulating member 18 electrically insulates the terminal 16 from the container 3. Inside the inner cavity of the container body 5, the positive electrode current collecting tab 11B and the positive electrode lead are electrically insulated from the container 3 by an insulating member (not shown). Similarly, inside the inner cavity of the container body 5, the negative electrode current collecting tab 12B and the negative electrode lead are electrically insulated from the container 3 by an insulating member (not shown).

Furthermore, inside the inner cavity, the electrode group 10 holds (is impregnated with) an electrolytic solution (not shown). The electrolytic solution may be a nonaqueous electrolytic solution obtained by dissolving an electrolyte in an organic solvent, or an aqueous electrolytic solution such as an aqueous solution. Instead of the electrolytic solution, a gel electrolyte may be used, and a solid electrolyte may be used. If a solid electrolyte is used as an electrolyte, a solid electrolyte is interposed between the positive electrode and the negative electrode instead of the separator in the electrode group. The solid electrolyte achieves electrical insulation between the positive electrode and the negative electrode.

The configurations of the battery and the electrode group of the embodiment, etc. are not limited to the above-described configurations. A battery mounted on the battery module may include a pair of terminals as a positive electrode terminal and a negative electrode terminal and be electrically connected to another battery via a later-described bus bar.

[Battery Module]

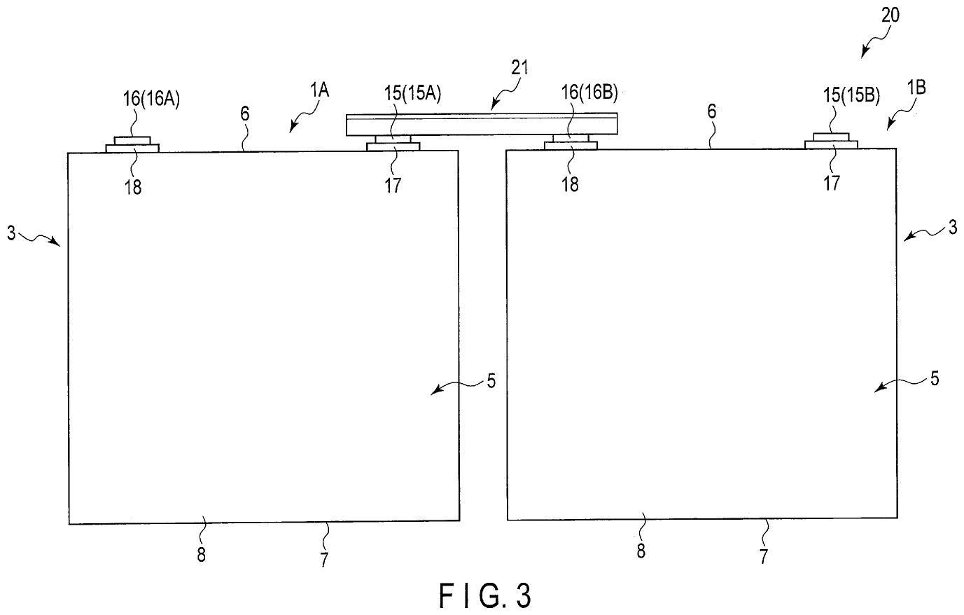

Next, a description will be given of a battery module including a plurality of batteries as described above. FIG. 3 shows an example of a battery module 20. The battery module 20 includes batteries 1A and 1B. The batteries 1A and 1B have a structures similar to those of the battery 1 shown as an example in FIG. 1. In the battery module 20, a bus bar 21 electrically connects a terminal (first terminal) 15A of the battery (first battery) 1A and a terminal (second terminal) 16B of the battery (second battery) 1B. Therefore, the bus bar 21 is bonded to each of the terminals 15A and 16B by laser welding, etc.

Here, the terminal 15A is a positive electrode in the battery 1A while the terminal 16B is a negative electrode in the battery 1B. Thus, in the example of FIG. 3, the batteries 1A and 1B are electrically connected in series by the bus bar 21. In another example, two batteries may be electrically connected in parallel using two bus bars similar to the bus bar 21. In this case, one of the two bus bars electrically connects positive electrode terminals of the two batteries. Then, one of the two bus bars electrically connects negative electrode terminals of the two batteries.

[Bus Bar]

Hereinafter, a bus bar according to embodiments will be described. The bus bar electrically connects two terminals as described above. For example, in the battery module including the first battery and the second battery, the bus bar electrically connects the first terminal of the first battery and the second terminal of the second battery. The bus bar is made of an electro-conductive material such as a metal. In an example, a member obtained by applying nickel plating to aluminum is used as a bus bar.

### First Embodiment

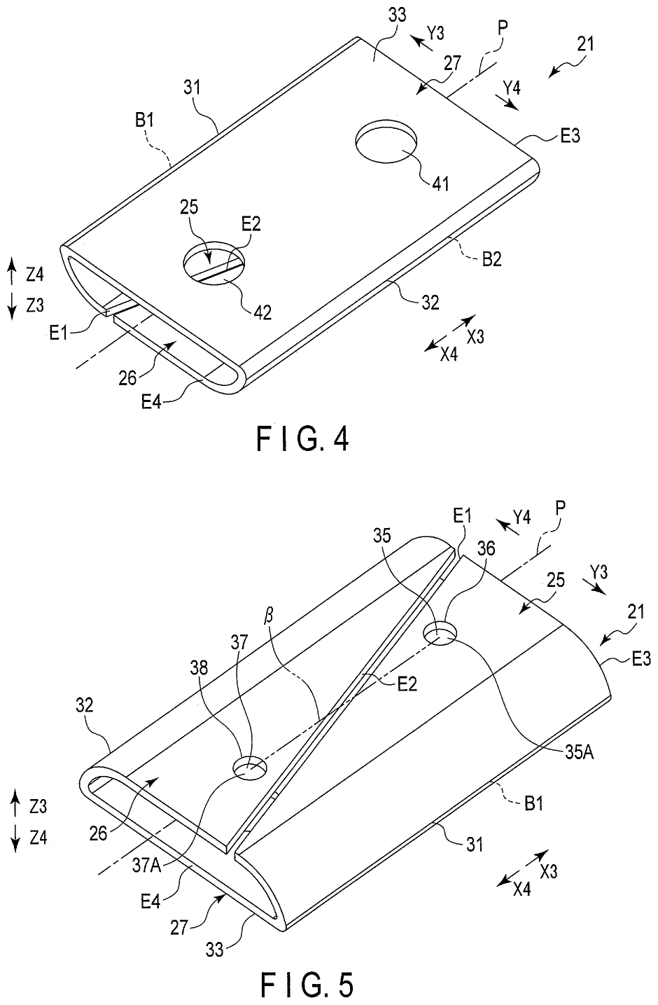

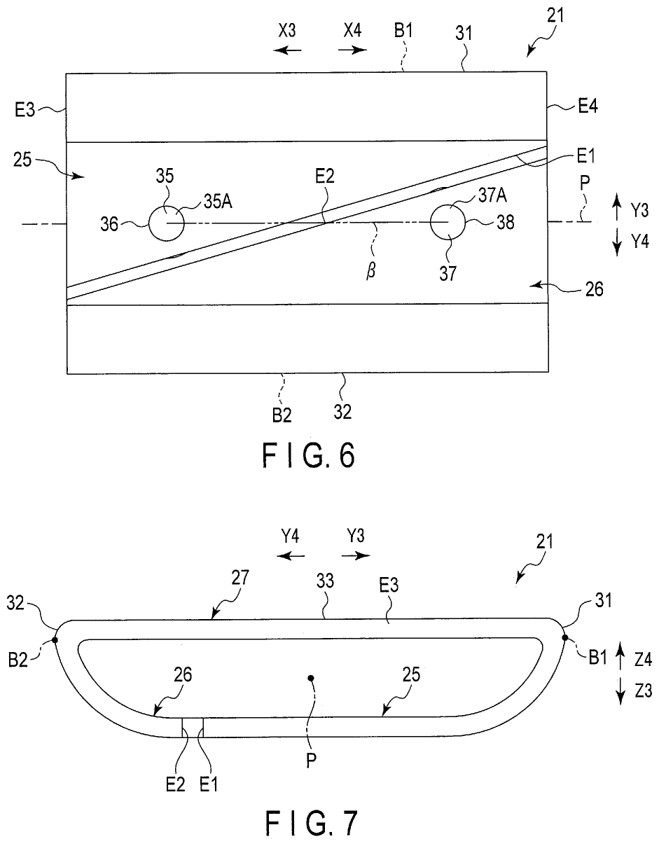

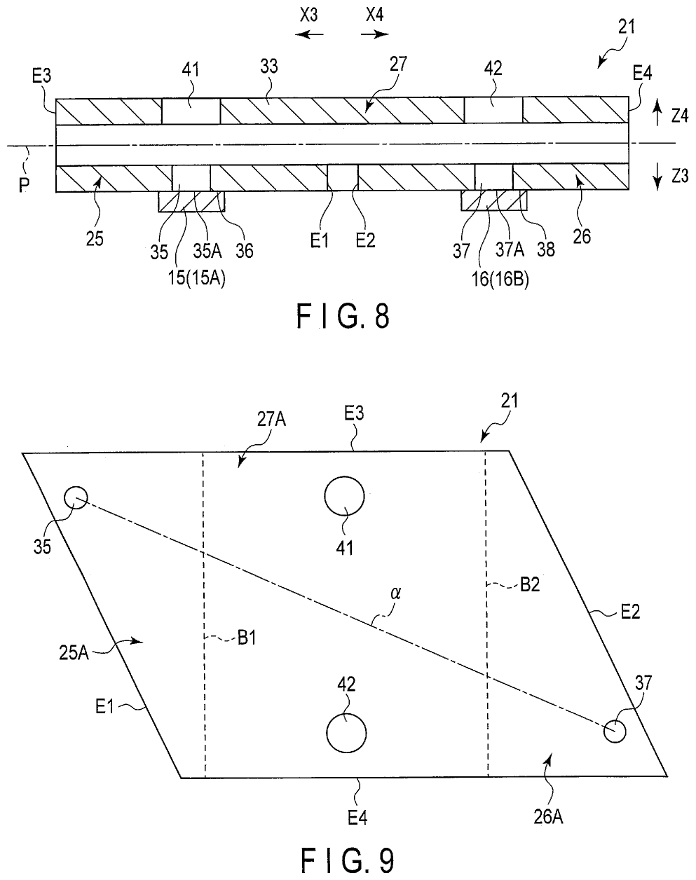

FIGS. 4 to 7 show a bus bar 21 according to the first embodiment, and FIG. 8 shows a state in which two terminals 15A and 16B are electrically connected by the bus bar 21. As shown in FIGS. 4 to 8, etc., the bus bar 21 is defined in terms of a first direction (direction indicated by arrows X3 and X4), a second direction (direction indicated by arrows Y3 and Y4) intersecting (perpendicular or substantially perpendicular to) the first direction, and a third direction (direction indicated by arrows Z3 and Z4) intersecting (perpendicular or substantially perpendicular to) both the first direction and the second direction. FIGS. 4 and 5 are perspective views showing the bus bar 21 viewed from directions different from each other. FIG. 6 shows the bus bar 21 viewed from one side (arrow Z3 side) of the third direction, and FIG. 7 shows the bus bar 21 viewed from one side (arrow X3 side) of the first direction. FIG. 8 shows the bus bar 21 through a section perpendicular to or substantially perpendicular to the second direction, with structural elements other than a terminal 15A in a battery 1A and structural elements other than a terminal 16B in a battery 1B omitted.

As shown in FIGS. 4 to 8, the bus bar 21 includes an edge (first edge) E1 and an edge (second edge) E2 opposite to the edge E1. In addition, the bus bar 21 includes an edge (third edge) E3 and an edge (fourth edge) E4 opposite to the edge E3. The edges E3 and E4 each continuously extend from the edge E1 to the edge E2.

The bus bar 21 includes a connector (first connector) bonded to a terminal (first terminal) 15A, and a connector (second connector) 26 bonded to a terminal (second terminal) 16B. The bus bar 21 further includes a relay 27 extending between the connectors 25 and 26. At a boundary between the connector 25 and the relay 27, a folded part (first folded part) 31 is formed. At the folded part 31, the connector 25 is folded with respect to the relay 27. That is, the connector 25 is bent at an angle of 180° or substantially 180° with respect to the relay 27. At a boundary between the connector 26 and the relay 27, a folded part (second folded part) 32 is formed. At the folded part 32, the connector 26 is folded with respect to the relay 27. That is, the connector 26 is bent at an angle of 180° or substantially 180° with respect to the relay 27.

The folded parts 31 and 32 are separated from each other in the second direction. The relay 27 relays between the folded parts 31 and 32, and continuously extend from the folded part 31 to the folded part 32 along the second direction. At the folded part (first folded part) 31, a folding line (first folding line) B1 of the connector 25 with respect to the relay 27 is formed. The folding line B1 is formed from the edge E3 to the edge E4 along the first direction. In the folded part (second folded part) 32, a folding line (second folding line) B2 of the connector 26 with respect to the relay 27 is formed. The folding line B2 is formed from the edge E3 to the edge E4 along the first direction.

At the bus bar 21, the entire edge E1 is formed by the connector (first connector) 25. In the connector 25, the edge E1 forms an end on a side opposite to the folded part 31. The connector 25 continuously extends from the folded part 31 to the edge E1 along the second direction. The connector 25 extends from the folded part 31 to the edge E1 toward a side in which the folded part 32 is positioned in the second direction. That is, the connector 25 extends from the folded part 31 toward an inner side in the second direction.

In addition, in the bus bar 21, the entire edge E2 is formed by the connector (second connector) 26. In the connector 26, the edge E2 forms an end on a side opposite to the folded part 32. The connector 26 continuously extends from the folded part 32 to the edge E2 along the second direction. The connector 26 extends from the folded part 32 to the edge E2 toward a side in which the folded part 31 is positioned in the second direction. That is, the connector 26 extends from the folded part 32 toward the inner side in the second direction.

In the bus bar 21, each of the edges E1 and E2 is arranged on a side closer to the folded part 31 with respect to the folded part 32 in the second direction. Furthermore, each of the edges E1 and E2 is arranged on a side closer to the folded part 32 with respect to the folded part 31 in the second direction. Thus, the edges E1 and E2 are arranged on inner sides with respect to the folded parts 31 and 32 in the second direction.

In the bus bar 21, the edge (first edge) E1 faces the edge (second edge) E2. However, the edge E1 has a gap with the edge E2, and is out of contact with the edge E2. Therefore, from the edge E1 to the edge E2, the bus bar 21 is continuous, passing through the connector (first connector) 25, the folded part (first folded part) 31, the relay 27, the folded part (second folded part) 32, and the connector (second connector) 26 in this order. That is, the edges E1 and E2 are continuous through the connector (first connector) 25, the folded part (first folded part) 31, the relay 27, the folded part (second folded part) 32, and the connector (second connector) 26. In the bus bar 21, the edge E1 is arranged on a side closer to the folded part 31 with respect to the edge E2 in the second direction. Thus, the edge E1 faces the edge E2 from the side in which the folded part 31 is positioned in the second direction.

Furthermore, the edges E1 and E2 extend parallel to or substantially parallel to each other. The direction in which each of the edges E1 and E2 extends is perpendicular to or substantially perpendicular to the third direction, and inclined with respect to the first and second directions. In the present embodiment, each of the edges E1 and E2 extends in such a manner that it comes closer to the folded part 31 as it comes closer to the edge E4.

As described above, the bus bar 21 is folded at each of the folded parts 31 and 32 between the edges E1 and E2. Thus, the bus bar 21 is folded twice (an even number of times) between the edges E1 and E2. Because of the configuration as described above, in the present embodiment, no folded part is formed in the relay 27. The relay 27 is formed by an extending part 33 which continuously extends from the folded part 31 to the folded part 32.

Since the folded parts 31 and 32 are formed as described above, the bus bar 21 has a loop shape in which a gap is formed between the edges E1 and E2 when viewed from each of both sides of the first direction. In addition, since the folded parts 31 and 32 are formed as described above, the bus bar 21 has a smaller dimension in the third direction than both the dimension in the first direction and the dimension in the second direction.

In a state in which the connector 25 is bonded to the terminal 15A and the connector 26 is bonded to the terminal 16B, the terminal (first terminal) 15A is arranged on a side in which the terminal (second terminal) 16B is positioned with respect to the connectors 25 and 26 in the third direction. In a state in which the connector is bonded to the terminal 15A, the relay 27 is positioned on a side opposite to a side in which the terminal 15A is positioned with respect to the connector 25 in the third direction. Thus, the connector 25 is bonded to the terminal 15A in a state of being positioned between the terminal 15A and the relay 27 in the third direction.

In a state in which the connector 26 is bonded to the terminal 16B, the relay 27 is positioned on a side opposite to a side in which the terminal 16B is positioned with respect to the connector 26 in the third direction. Thus, the connector 26 is bonded to the terminal 16B in a state of being positioned between the terminal 16B and the relay 27 in the third direction. The connectors 25 and 26 are not deviated or are rarely deviated from each other in the third direction. The connectors 25 and 26 are spaced at a minute interval from the relay 27 in the third direction and are out of contact with the relay 27. That is, the connectors 25 and 26 are each positioned on a side in which the terminal (first terminal) 15A and the terminal (second terminal) 16B are positioned with respect to the relay 27 in the third direction. The relay 27 is positioned on a side opposite to a side in which the terminal (first terminal) 15A and the terminal (second terminal) 1 GB are positioned with respect to the connectors 25 and 26.

The connector 25 includes a through-hole 35. The through-hole 35 extends along the third direction. The through-hole 35 penetrates through the connector 25 from a surface facing the side in which the relay 27 is positioned to a surface facing the side opposite to the side in which the relay 27 is positioned. Thus, in the connector 25, an opening 35A of the through-hole 35 is formed on the surface facing the side opposite to the side in which the relay 27 is positioned. The connector 25 is bonded to the terminal 15A at and in the vicinity of the opening edge of the opening 35A. Thus, in the connector 25, the surface facing the side opposite to the side in which the relay 27 is positioned is provided with a bonded portion (first bonded portion) 36 bonded to the terminal (first terminal) 15A at and in the vicinity of the opening edge of the opening 35A.

The connector 26 includes a through-hole 37. The through-hole 37 extends along the third direction. The through-hole 37 penetrates through the connector 26 from a surface facing the side in which the relay 27 is positioned to a surface facing the side opposite to the side in which the relay 27 is positioned. Thus, in the connector 26, an opening 37A of the through-hole 37 is formed on the surface facing the side opposite to the side in which the relay 27 is positioned. The connector 26 is bonded to the terminal 16B at and in the vicinity of the opening edge of the opening 37A. Thus, in the connector 26, the surface facing the side opposite to the side in which the relay 27 is positioned is provided with a bonded portion (second bonded portion) 38 bonded to the terminal (second terminal) 16B at and in the vicinity of the opening edge of the opening 37A.

In the bus bar 21, the through-holes 35 and 37 are separated from each other in the first direction. Thus, in the bus bar 21, the bonded portions 36 and 38 are formed apart from each other in the first direction. In a state in which the connector 25 is bonded to the terminal 15A and the connector 26 is bonded to the terminal 16B, the terminals 15A and 16B are arranged away from each other in the first direction of the bus bar 21.

As described above, the connectors 25 and 26 are not deviated or are rarely deviated from each other in the third direction. The through-holes 35 and 37 are not deviated or are rarely deviated from each other in the third direction. The bonded portions 36 and 38 are not deviated or are rarely deviated from each other in the third direction. The through-holes 35 and 37 are not deviated or are rarely deviated from each other in the second direction as well. Thus, the bonded portions 36 and 38 are not deviated or are rarely deviated from each other in the second direction.

Since the through-holes 35 and 37 and the bonded portions 36 and 38 are formed as described above, in the bus bar 21, an imaginary line β connecting the through-holes 35 and 37 extends along the first direction. An imaginary line connecting the bonded portions 36 and 38 is also along the first direction. In a state in which the bonded portion 36 of the connector 25 is bonded to the terminal 15A and the bonded portion 38 of the connector 26 is bonded to the terminal 16B, an imaginary line connecting the terminal (first terminal) 15A and the terminal (second terminal) 16B extends along the first direction of the bus bar 21. Thus, the extending direction of the imaginary line connecting the terminals 15A and 16B intersects (perpendicular to or substantially perpendicular to) the second direction of the bus bar 21.

The relay 27 includes through-holes 41 and 42. The through-holes 41 and 42 each extend along the third direction. The through-holes 41 and 42 each penetrate through the relay 27 from the surface facing the side in which the connectors 25 and 26 are positioned to the surface facing the side opposite to the side in which the connectors 25 and 26 are positioned.

The through-hole 41 is not deviated or is rarely deviated from the through-hole 35 of the connector 25 in the first and second directions. Thus, the through-hole 41 is formed coaxially or substantially coaxially with respect to the through-hole 35. In working to bond the bonded portion 36 of the connector 25 to the terminal 15A, bonding by laser welding, etc. is conducted through the through-holes 41 and 35.

The through-hole 42 is not deviated or is rarely deviated from the through-hole 37 of the connector 26 in the first and second directions. Thus, the through-hole 42 is formed coaxially or substantially coaxially with respect to the through-hole 37. In working to bond the bonded portion 38 of the connector 26 to the terminal 16B, bonding by laser welding, etc. is conducted through the through-holes 42 and 37.

As described above, the through-hole 41 is coaxial or substantially coaxial with respect to the through-hole 35, and the through-hole 42 is coaxial or substantially coaxial with respect to the through-hole 37. The through-holes 41 and 42 are not deviated or are rarely deviated from each other in the second direction. Thus, an imaginary line (not shown) connecting the through-holes 41 and 42 extends along the first direction.

FIG. 9 shows the bus bar 21 in a state of being not folded at the folded parts 31 and 32, i.e., in a state of being developed. When the bus bar 21 is formed, a part 25A is folded with respect to a part 27A at the folding line (first folding line) B1. Then, a part 26A is folded with respect to a part 27A at the folding line (second folding line) B2. Thus, the part 25A between the folding line B1 and the edge E1 forms the connector (first connector) 25, and the part 26A between the folding line B2 and the edge E2 forms the connector (second connector) 26. The part 27A between the folding lines B1 and B2 forms the relay 27.

By folding at the folding line B1, the through-hole overlaps the through-hole 41, and is coaxial or substantially coaxial with respect to the through-hole 41. By folding at the folding line B2, the through-hole 37 overlaps the through-hole 42, and is coaxial or substantially coaxial with respect to the through-hole 42. Furthermore, an electrical path between the bonded portions 36 and 38 in the bus bar 21, i.e., an electrical path between the terminals 15A and 16B extends along an imaginary line α connecting the through-holes 35 and 37 in the state of FIG. 9 (developed state).

From the state of FIG. 9 to the state in which the folded parts 31 and 32 are formed, the imaginary line a of FIG. 9 extends in a spiral manner around a center axis P. Thus, in the bus bar 21, the electrical path between the terminals 15A and 16B is formed in a spiral manner around the center axis P. The electrical path between the terminals 15A and 16B is formed by passing through the connector (first connector) 25, the relay 27, and the connector (second connector) 26. The center axis P is positioned between the connectors (first and second connectors) 25 and 26 and the relay 27 (preferably in an intermediate of the connectors 25 and 26 and the relay 27) in the third direction. In addition, the center axis P is positioned between the folded parts 31 and 32 (preferably in an intermediate of the folded parts 31 and 32) in the second direction. The center axis P is an imaginary line along the first direction, and constitutes the center axis of the entire bus bar 21 shown in FIGS. 4 and 5. It is preferable that the imaginary line β connecting the through-holes 35 and 37 be parallel to the center axis P, and the imaginary line β be apart from the center axis P in the third direction. The imaginary line β is not deviated or is rarely deviated from the center axis P in the second direction.

The electrical resistance of the electrical path formed in the bus bar 21 increases if the length of the electrical path is longer. The electrical resistance of the electrical path decreases if a cross-sectional area perpendicular to the extending direction of the electrical path increases. In the present embodiment, since the bus bar 21 has the configuration as described above, in the bus bar 21, the electrical path between the terminals 15A and 16B is formed in a spiral manner around the center axis P along the first direction. Since the electrical path is formed as described above, in the electrical path of the bus bar 21, the cross-sectional area perpendicular to the extending direction increases. When the cross-sectional area perpendicular to the extending direction of the electrical path increases, the electrical resistance of the electrical path of the bus bar 21 decreases. This can reduce the amount of Joule heat in the bus bar 21, reducing the temperature increase of the bus bar 21 due to Joule heat.

Furthermore, in the bus bar 21, the electrical path is formed in a spiral manner around the center axis P; thus, even when the bus bar 21 is formed thinner, the cross-sectional area perpendicular to the extending direction of the electrical path is maintained to be large to some extent. Therefore, even when the bus bar 21 is formed thinner, the amount of Joule heat in the bus bar 21 can be reduced, lowering the temperature of the bus bar 21. Reducing the thickness (board thickness) of the bus bar 21 facilitates bonding of each of the connectors 25 and 26 to a corresponding one of the terminals 15A and 16B by laser welding, etc.

Furthermore, in the present embodiment, since the bus bar 21 has the configuration as described above, the bus bar 21 has a loop shape in which a gap is formed between the edges E1 and E2. By forming the bus bar 21 into a shape as described above, the surface area of the bus bar 21 increases. With an increase in the surface area of the bus bar 21, even in a case where Joule heat occurs, the bus bar 21 is easily cooled by air or the like. This can further reduce the temperature increase of the bus bar 21 due to Joule heat.

Further, because the bus bar 21 is formed into a shape as described above, if the bus bar 21 thermally expands due to the temperature increase, the connectors 25 and 26 move relative to each other in each of the direction along the edges E1 and E2 and the third direction. Thus, even if the bus bar 21 thermally expands, the stress acting on the bonded portion 36 to the terminal 15A is reduced in the connector 25. Similarly, even if the bus bar 21 thermally expands, the stress acting on the bonded portion 38 to the terminal 16B is reduced in the connector 26.

As described above, in the bus bar 21 of the present embodiment, the temperature increase due to Joule heat is decreased, and the stress acting on the bonded portions 36 and 38 is reduced even it thermal expansion occurs due to the temperature increase. Therefore, in a state in which the current is flowing in the bus bar 21 and Joule heat is occurring, it is possible to adequately secure bonding of each of the connectors 25 and 26 to a corresponding one of the terminals 15A and 16B.

Furthermore, in the present embodiment, because the bus bar 21 is formed into a shape as described above, the bus bar 21 has a smaller dimension in the third direction. Thus, in the battery module 20 including the batteries 1A and 1B and the bus bar 21, the amount of protrusion of the bus bar 21 from the batteries 1A and 1B to the outside becomes smaller. Therefore, the battery module 20 becomes small in volume and has a high energy density.

(Modifications)

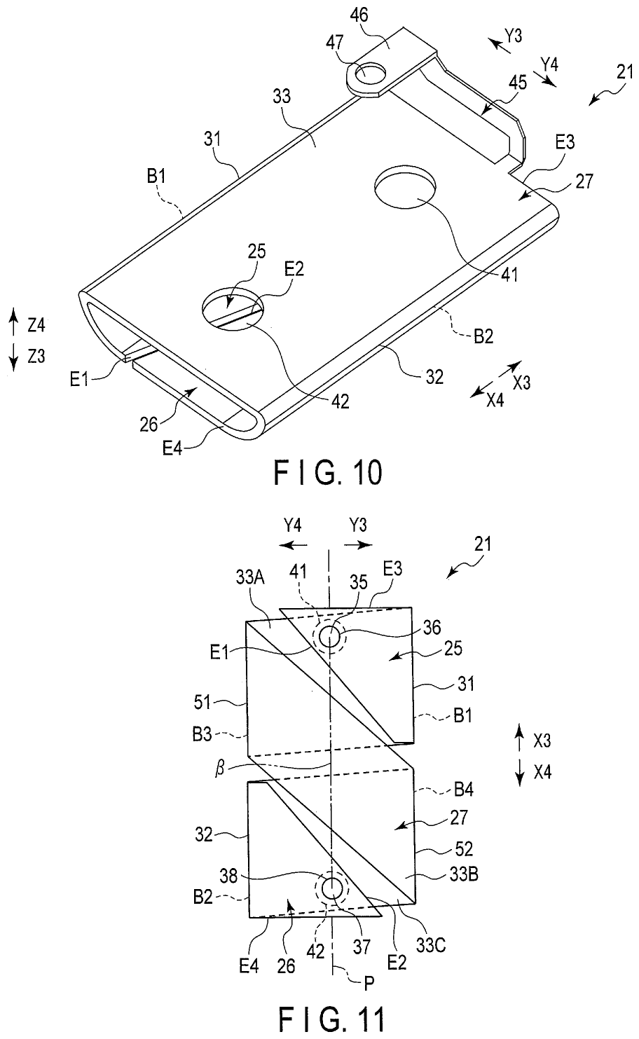

In a first modification shown in FIG. 10, the bus bar 21 includes a detection piece (detection line) 45. In this modification, one end of the detection piece 45 is connected to the relay 27. The other end of the detection piece 45 is provided with a connection plate 46. The connection plate 46 is arranged on a side opposite to the side in which the connectors 25 and 26 are positioned with respect to the relay 27 in the third direction. Further, the connection plate 46 includes a through-hole 47.

In the present modification, the battery module 20 including the above-described batteries 1A and 1B and the bus bar 21 is mounted on a battery pack (not shown). The battery pack on which the battery module 20 is mounted is provided with a detection circuit (not shown) detecting a current and a voltage, and a detector (not shown) such as a thermistor detecting a temperature. The connection plate 46 of the detection piece 45 is connected to a terminal provided in the above-described detection circuit or detector. The connection plate 46 is bonded by laser welding, etc. to the terminal of the detection circuit or the detector at a portion in the vicinity of the through-hole 47.

Here, in a battery pack, etc., the detection circuit and the detector are arranged on a side opposite to the side in which the batteries 1A and 1B are positioned with respect to the bus bar 21. Thus, with the configuration as in the present modification in which the detection piece is connected to the relay 27, a path formed by the detection piece 45 from the battery module 20 to the detection circuit, etc. becomes short. If the path from the battery module 20 to the detection circuit, etc. is shorter, a detection accuracy of the current, temperature, etc. is increased.

Furthermore, in the bus bar 21, at and in the vicinity of the connection parts (bonded portions 36 and 38) of the connectors 25 and 26, etc. to the terminals 15A and 16B, the current may increase locally, or the temperature may increase locally. In contrast, phenomena as described above are unlikely to occur in the relay 27 away from the connection parts to the terminals 15A and 16B. Therefore, with the detection piece 45 configured to be connected to the relay 27 as in the present modification, the detection accuracy of the current, temperature, etc. is further increased.

In the bus bar 21 having a loop shape in which a gap is formed between the edges E1 and E2, when thermal expansion occurs due to a temperature increase, the relay 27 is not easily deformed as compared to the connectors 25 and 26. Therefore, with the detection piece 45 configured to be connected to the relay 27 as in the present modification, even when the bus bar 21 thermally expands, bonding of the detection piece 45 to the terminal of the detection circuit or the detector is adequately secured.

Furthermore, in the above-described embodiment, etc., the relay 27 (extending part 33) between the folded parts 31 and 32 has no folded part; however, the embodiments are not limited to this. In the second modification shown in FIG. 11, the above-described folded parts 31 and 32 are formed, and two folded parts 51 and 52 are formed in the relay 27 between the folded parts 31 and 32. The relay 27 includes extending parts 33A to 33C. In the relay 27, the extending part 33A extends along the second direction in a continuous manner from the folded part 31 to the folded part 51. The extending part 33B extends along the second direction in a continuous manner from the folded part 51 to the folded part 52. The extending part 33C extends along the second direction from the folded part 52 to the folded part 32.

In the present modification also, the folded parts 31 and 32 are separated from each other in the second direction. Furthermore, in the present modification, the folded part 51 is separated from the folded part 31 in the second direction toward the side in which the folded part 32 is positioned. The folded part 52 is separated from the folded part 32 in the second direction toward the side in which the folded part 31 is positioned.

In the present modification also, the connector 25 is folded with respect to the extending part 33A of the relay in the folded part 31. In the folded part 31, the folding line B1 along the first direction is formed. In the present modification also, the connector 25 extends from the folded part 31 to the edge E1 toward a side in which the folded part 32 (folded part 51) is positioned in the second direction. Further, in the present modification, the connector 26 is folded with respect to the extending part 33C of the relay 27 in the folded part 32. In the folded part 32, the folding line B2 along the first direction is formed. In the present modification, the connector 26 extends from the folded part 32 to the edge E2 toward a side in which the folded part 31 (folded part 52) is positioned in the second direction.

In the present modification, the extending part 33A is folded with respect to the extending part 33B in the folded part 51, and the folding line B3 along the first direction is formed in the folded part 51. The extending part 33C is folded with respect to the extending part 33B in the folded part 52, and the folding line B4 along the first direction is formed in the folded part 52. In the present modification, the bus bar 21 is folded at each of the folded parts 31 and 32, and also folded at each of the folded parts 51 and 52. Thus, the bus bar 21 is folded four times (an even number of times) between the edges E1 and E2.

In the present modification also, the connector 25 is provided with the bonded portion 36 bonded to the terminal (first terminal) 15A, and the connector 26 is provided with the bonded portion 38 bonded to the terminal (second terminal) 16B. An imaginary line connecting the bonded portions 36 and 38, i.e., an imaginary line β connecting the through-holes 35 and 37, extends along the first direction. Thus, in the present modification also, in a state in which the connector 25 (bonded portion 36) is bonded to the terminal 15A and the connector 26 (bonded portion 38) is bonded to the terminal 16B, the terminals 15A and 16B are separated from each other in the first direction of the bus bar 21.

In the present modification, the connector 25 is bonded to the terminal 15A in a state of being positioned between the terminal 15A and the extending part 33A of the relay 27 in the third direction. The connector 26 is bonded to the terminal 16B in a state of being positioned between the terminal 16B and the extending part 33C of the relay 27 in the third direction. The extending part 33B is positioned on a side in which the connectors 25 and 26 are arranged with respect to the extending parts 33A and 33C in the third direction. That is, the extending part 33B is positioned on a side in which the terminals 15A and 16B are arranged with respect to the extending parts 33A and 33C in the third direction. The extending part 33B is not deviated or is rarely deviated with respect to the connector 25 or 26 in the third direction.

In the present modification as well, the electrical path between the terminals 15A and 16B is formed in a spiral manner around the center axis P along the first direction. With the configurations as described above, the present modification exhibits similar advantageous effects to those of the above-described embodiment.

As long as the bus bar 21 is folded an even number of times between the edges E1 and E2 and the connectors 25 and 26 have configurations similar to those in the above-described embodiment, the bus bar 21 may be folded six times or more between the edges E1 and E2. In this case, in the relay 27 between the folded parts 31 and 32, folded parts are formed at four or more portions.

In the above-described embodiments, etc., in the battery module, etc., the bus bar 21 electrically connects the terminal of the first battery and the terminal of the second battery that is different from the first battery. However, two terminals electrically connected by the bus bar 21 are not necessarily provided in the battery, and the bus bar 21 of each embodiments may be used for connection between terminals provided in other electrical equipment.

In at least one of these embodiments and examples, two terminals separated in the first direction are connected by the bus bar. In the bus bar, the first folded part and the second folded part are separated from each other in the second direction intersecting the first direction. In the bus bar, the relay relays between the first folded part and the second folded part. In the bus bar, the first connector is bonded to one of the terminals, and extends from the first folded part to the side in which the second folded part is positioned. In the bus bar, the second connector is bonded to the other terminal, and extends from the second folded part to the side in which the first folded part is positioned. In this manner, it is possible to provide a bus bar that reduces a temperature increase due to Joule heat and reduces a stress acting on a portion bonded the terminal due to thermal expansion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A bus bar electrically connecting a first terminal and a second terminal separated from each other in a first direction, the bus bar comprising:
a first folded part;
a second folded part formed apart from the first folded part in a second direction intersecting the first direction;
a relay relaying between the first folded part and the second folded part;
a first connector bonded to the first terminal, and folded with respect to the relay at the first folded part, the first connector extending from the first folded part toward a side in which the second folded part is positioned in the second direction; and
a second connector bonded to the second terminal, and folded with respect to the relay at the second folded part, the second connector extending from the second folded part toward a side in which the first folded part is positioned in the second direction.

2. The bus bar according to claim 1, wherein
the first connector forms a first edge, and extends to the first edge toward the side in which the second folded part is positioned in the second direction,
the second connector forms a second edge on a side opposite to the first edge, and extends to the second edge toward the side in which the first folded part is positioned in the second direction, and
the first edge and the second edge are continuous through the first connector, the first folded part, the relay, the second folded part, and the second connector.

3. The bus bar according to claim 2, wherein the first edge faces the second edge and has a gap with the second edge in the second direction.

4. The bus bar according to claim 1, wherein
the first terminal is arranged on a side in which the second terminal is positioned with respect to the first connector and the second connector in a third direction intersecting both the first direction and the second direction,
the first connector is positioned between the relay and the first terminal in the third direction, and
the second connector is positioned between the relay and the second terminal in the third direction.

5. The bus bar according to claim 1, wherein
a first folding line of the first connector with respect to the relay is formed along the first direction in the first folded part, and
a second folding line of the second connector with respect to the relay is formed along the first direction in the second folded part.

6. The bus bar according to claim 1, wherein an electrical path between the first terminal and the second terminal is formed to pass through the first connector, the relay, and the second connector, in a spiral manner around a center axis along the first direction.

7. A battery module, comprising:
the bus bar according to claim 1;
a first battery including the first terminal to which the first connector of the bus bar is bonded; and
a second battery including the second terminal to which the second connector of the bus bar is bonded, the second terminal being electrically connected to the first terminal via the bus bar.
